(19) United States
(12) Patent Application Publication
(10) Pub. No.: US 2024/0352820 A1
(43) Pub. Date: Oct. 24, 2024

(54) WELL STRUCTURE ADAPTATIONS AND CONNECTIONS FOR REUSABLE OIL AND GAS STRUCTURES

(71) Applicant: Baker Hughes Oilfield Operations LLC, Houston, TX (US)

(72) Inventors: Joseph Shu Yian Liew, Singapore (SG); Keith Adams, Katy, TX (US); Alejandro Rodela, Houston, TX (US); Kailey Euceda, Houston, TX (US); Pascal Berthaud, Abu Dubai (AE)

(73) Assignee: Baker Hughes Oilfield Operations LLC, Houston, TX (US)

(21) Appl. No.: 18/275,451

(22) PCT Filed: May 12, 2023
(86) PCT No.: PCT/US23/22022

§ 371 Date: Aug. 2, 2023

Related U.S. Application Data
(60) Provisional application No. 63/341,272, filed on May 12, 2022.

(51) Int. Cl. E21B 33/037; F03D 13/20

(52) U.S. Cl. CPC E21B 33/037; F03D 13/206; F05B 2240/911

(57) ABSTRACT

A system and method (1000; 1050) for a well structure adaption (402) to be used with a wellhead casing for a reusable system (942; 962A; 962B), such as a system for renewable energy generation is disclosed. A well structure adaption includes an annular feature (404; 506) and a housing (412; 504). The annular feature includes a narrowing (406) therein and is able to fit over the wellhead casing (110; 202). The housing is associated with a segmented clamp (508) and a drive screw (502). The housing is to fit over a portion of the annular feature. The drive screw is to enable the housing to be releasably clamped to the annular feature with the segmented clamp. The housing can support at least one aspect of a reusable system thereon.

### CROSS-REFERENCES TO RELATED APPLICATIONS

This application is a National Stage application of PCT Application No. PCT/US2023/022022 filed May 12, 2023, titled WELL STRUCTURE ADAPTATIONS AND CONNECTIONS FOR REUSABLE OIL AND GAS STRUCTURES, which claims the benefit of priority from U.S. Provisional Application 63/341,272 filed May 12, 2022, titled WELL STRUCTURE ADAPTATIONS AND CONNECTIONS FOR RENEWABLE ENERGY GENERATION, the entire disclosures of both of which are incorporated by reference herein for all intents and purposes.

### BACKGROUND

### 1. Field of Invention

This invention relates in general to equipment used in onshore or offshore oil and gas structures, and in particular, to well structure adaptions for reusable systems on the onshore or offshore oil and gas structures.

### 2. Description of the Prior Art

Mature oil and gas fields that are no longer commercially viable because of reservoir depletion may present unique environmental challenges for retained oil and gas structures. The process of decommissioning offshore platforms, for instance, is expensive, presents an environmental impact, and may not have been considered at the time the oil-and-gas structure was commissioned.

### SUMMARY

In at least one embodiment, a well structure adaption to be used with a wellhead casing is disclosed. The well structure adaptation includes an annular feature having a narrowing therein. The annular feature can fit over the wellhead casing. The well structure adaptation includes a housing associated with a segmented clamp and a drive screw. The housing can fit over an integrated portion of the annular feature. The drive screw can enable the housing to be releasably clamped to the annular feature with the segmented clamp. The housing can support at least one aspect of a reusable system thereon.

In at least one embodiment, a method for a well structure adaption to be used with a wellhead casing is disclosed. The method includes providing an annular feature having a narrowing therein. The annular feature can fit over the wellhead casing. The method includes enabling a housing to be associated with a segmented clamp and a drive screw. The housing can fit over an integrated portion of the annular feature. The drive screw can enable the housing to be releasably clamped to the annular feature with the segmented clamp. The housing can support at least one aspect of a reusable system thereon.

### BRIEF DESCRIPTION OF THE DRAWINGS

Various embodiments in accordance with the present disclosure will be described with reference to the drawings, in which:

FIG. 1 illustrates an example environment subject to improvements of at least one embodiment herein;

FIG. 2 illustrates a plurality of casings within the example environment, in at least one embodiment;

FIG. 3 illustrates remanent structures within the example environment, in at least one embodiment;

FIG. 4 illustrates aspects of a well structure adaption for a reusable system, according to at least one embodiment;

FIG. 5 illustrates details of the well structure adaption in an unlatched position, according to at least one embodiment;

FIG. 6 illustrates details of a well structure adaption in a latched position, according to at least one embodiment;

FIG. 7 illustrates details of a separation enabled within a well structure adaption for a reusable system, according to at least one embodiment;

FIG. 8 illustrates details a well structure adaption with buoyancy features for a reusable system, according to at least one embodiment;

FIG. 9A illustrates details a well structure adaption with details of a buoyancy feature, according to at least one embodiment;

FIG. 9B illustrates details for rotational movement associated with a well structure adaption, according to at least one embodiment;

FIG. 9C illustrates details of a renewable energy system associated with a well structure adaption for renewable energy generation, according to at least one embodiment;

FIG. 9D illustrates details of a renewable energy system associated with a well structure adaption, according to at least one embodiment;

FIG. 10A illustrates a method associated with a well structure adaption for renewable energy generation, according to at least one embodiment; and

FIG. 10B illustrates a method associated with a well structure adaption for a reusable system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. Various other functions can be implemented within the various embodiments as well as discussed and suggested elsewhere herein. In at least an aspect, the present disclosure is to a system and a method for a well structure adaption to be used with a wellhead casing and to support at least one aspect of a reusable system thereon. The reusable system reuses existing offshore oil and gas structures to enable renewable energy generation or to enable communication systems there with.

In at least one embodiment, such features can address issues previously described by converting commercially unviable wells and fields into another source or sink of clean energy, such a renewable energy from wind, wave, or water. In at least one embodiment, this also enables utility and extension of life for offshore leases on the well and results in enhanced energy production or usage for unviable wells and fields. In at least one embodiment, other benefits include addressing high costs associated with decommissioning of such unviable wells and fields, addressing environmental impacts and regulatory concerns associated with decommissioning of unviable wells and fields, and reducing carbon footprint, while also converting carbon footprints to carbon credits with associated financial benefits from green initiatives.

In at least one embodiment, a well structure adaptation may be provided by a well structure adapter that has or that supports a universal high-capacity connector as part of or as fully representing a conversion system. Such a well structure adapter enables rapid make up to convert existing wellhead casings; enables secured fixing based in part on two opposing tapered shoulders or angular clamping surfaces; enables preloaded connection; enables removable and replaceable bushings; enables anti-vibration features by securing such a well structure adapter to an interface or external surface; enables rotational adjustment of a full 360 degrees, whilst supporting heavy axial loads (such as loads of 221,000 lbs), supported by fluid column providing load bearing or mechanical thrust bearings; and enables anti-rotation feature to lock the well structure adapter in place.

In at least one embodiment, a well structure adaption may also enable a method of adjusting an elevation in an axial direction of a reusable system mounted thereon that may be one or more of a renewable energy system or a communication system. For example, the well structure adaption includes the reusable system mounted over a repurposed oil and gas platform/equipment that is decommissioned. The existing oil and gas platform/equipment is used in part with the well structure adaption to serve as additional support for the reusable system. In at least one embodiment, buoyancy canisters may be used to either raise or lower an axial position of an outer body associated with an annular feature of the well structure adaption.

In at least one embodiment, at least one motorized drive system may be associated with one or more of the annular feature or the housing to enable one more axial movements, including the raising and lowering of the axial position of the outer body or rotating the outer body of at least one aspect of the reusable system. A housing of the well structure adaption that is associated with the outer body may be raised or lowered, in turn, with the axial position of the outer body. As a result, a reusable system that may include a communications system or a renewable energy system like a wind turbine or solar energy panel can be raised or lowered, as well as rotated. An altitude adjustment, as well as the rotational adjustment, corresponding to different axial positions are useful to improve efficiency or working of the reusable system. For example, in a wind turbine or solar panel, dynamical altitude or rotational adjustment supports a favorable wind or solar condition for producing energy.

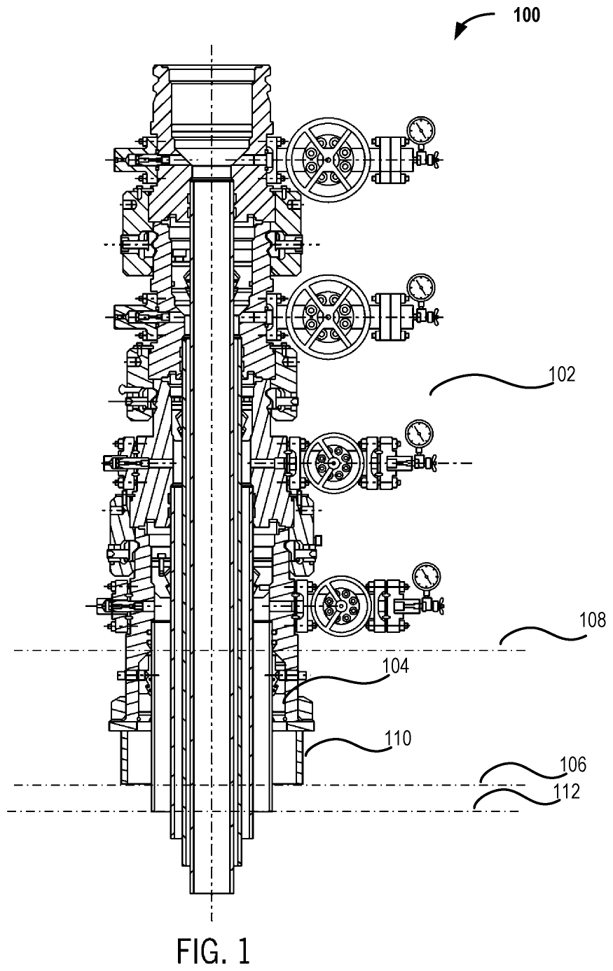

In at least one embodiment, FIG. 1 illustrates an example environment 100 subject to improvements herein. The example environment includes a wellhead and associated structures 102 over a series of wellhead casings 110 sitting above an external surface, such as a mud level 106. In at least one embodiment, an external surface 106 that may be a mud line or ocean floor 112 or may be a surface that is lower or higher than the mud level or ocean floor 112. A well structure adaption may be used with a wellhead casing 110 over a level 108 comprising at least one aspect of the wellhead casing 110. In at least one embodiment, the wellhead and the associated structures 102 is first removed till the at least one aspect 104 of the wellhead casing 110 is exposed for installation of a well structure adaption.

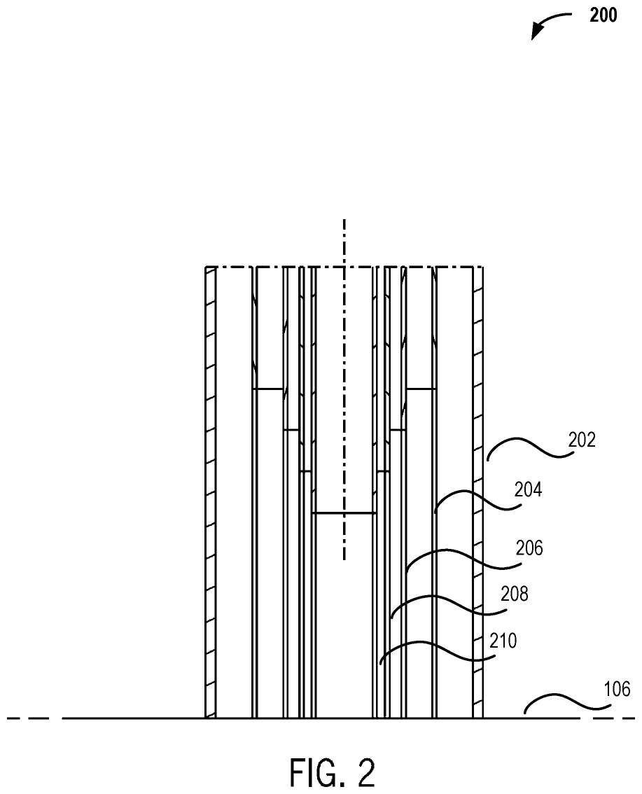

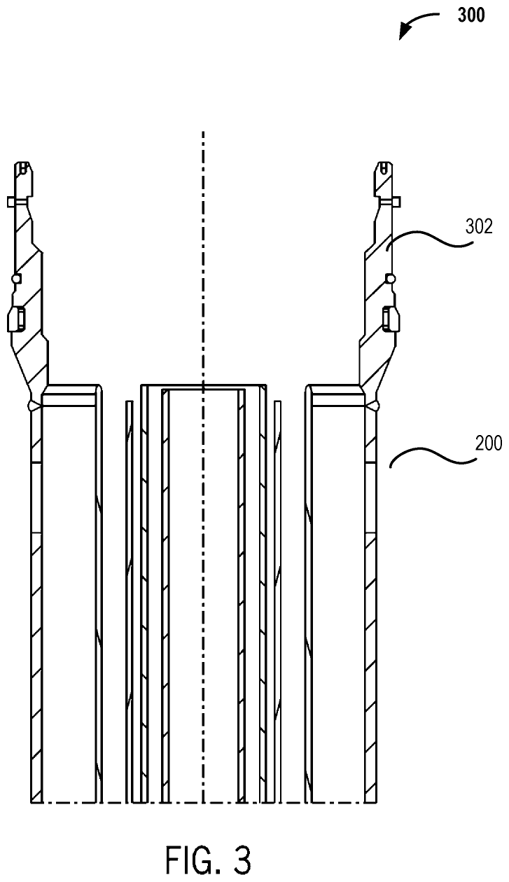

In at least one embodiment, FIG. 2 illustrates a plurality of casings 200 within the example environment, for a well structure adaption. The plurality of casings 200 may include a 30-inch outer or wellhead casing 202 extending from an external surface 106 that may be distinct from a mud line. The outer casing 202 may encompass or circumferentially cover a first inner casing 204 that may be a 18⅝-inch casing. A second inner casing 206 may be a 13⅜-inch casing, followed by a third inner casing 208 that may be a 10¾-inch casing. An inner bore or casing 210 is supported by all such prior casings 202-208 and may be a 7-inch diameter bore. A well structure adaption may be provided to fit over such casings 200. In at least one embodiment, FIG. 3 illustrates remanent structures 300 within the example environment 100 for associating with a well structure adaption. In at least one embodiment, such remanent structures 300 include at least a casing string 302 that may be part of the plurality of casing 200. Such remanent structures 300 may be the onshore or offshore oil and gas structures subject to the well structure adaptions for reusable systems herein.

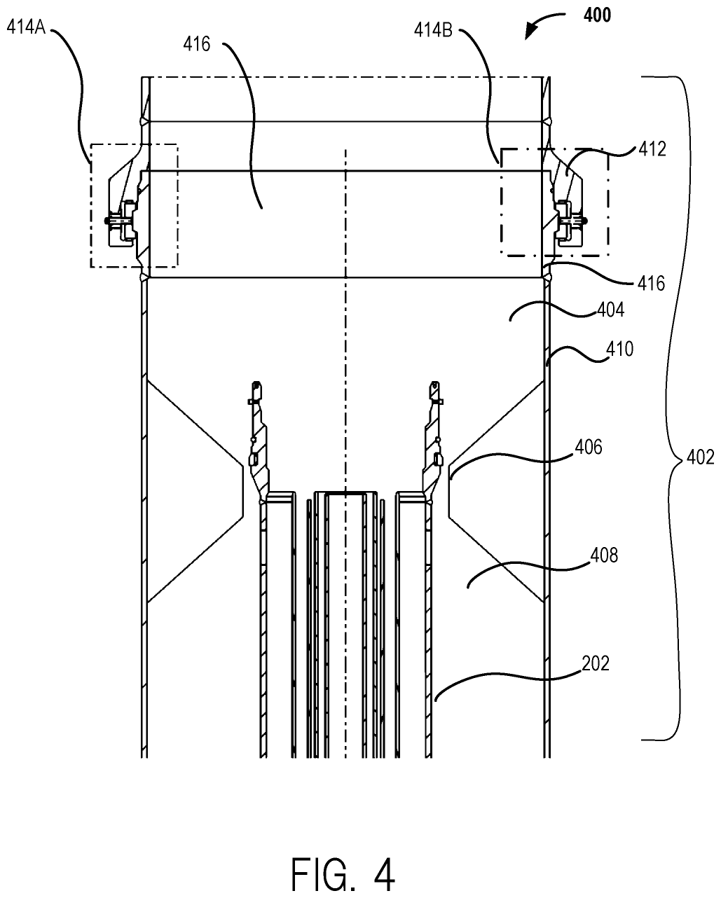

In at least one embodiment, FIG. 4 illustrates aspects 400 of a well structure adaption 402 for a reusable system, such as for a system for renewable energy generation. In at least one embodiment, such a well structure adaption 402 includes a narrowing 406 therein that is within an annular feature 404. The annular feature 404 can fit over the wellhead casing 202. In at least one embodiment, the annular feature 404 may be a 72-inch cassion and the narrowing 406 may be casing centralizer to provide guidance during installation. In at least one embodiment, concrete 408 may form any part of the well structure adaption that is between the casings 200 and the annular feature 404. In at least one embodiment, the annular feature 404 may include a first surface 410.

In at least one embodiment, the well structure adaptation 402 includes a housing 412. In at least one embodiment, the annular feature 404 includes an integrated portion 416 to be associated with the housing 412. As illustrated, the integrated portion 416 is an undivided or attached portions of the annular feature 404 that contacts one or more segmented clamps. For example, the segmented clamps, are devoid from a requirement to associate together two parts of an annular feature 404. As a result, the integrated portion is a single or unibody structure, as illustrated where the annular feature is latched onto by the housing using the segmented clamps in callouts 414A, B. In at least one embodiment, this ensures a strong and resilient, as well as agile well structure adaption for use with different wellhead casings and renewable energy systems.

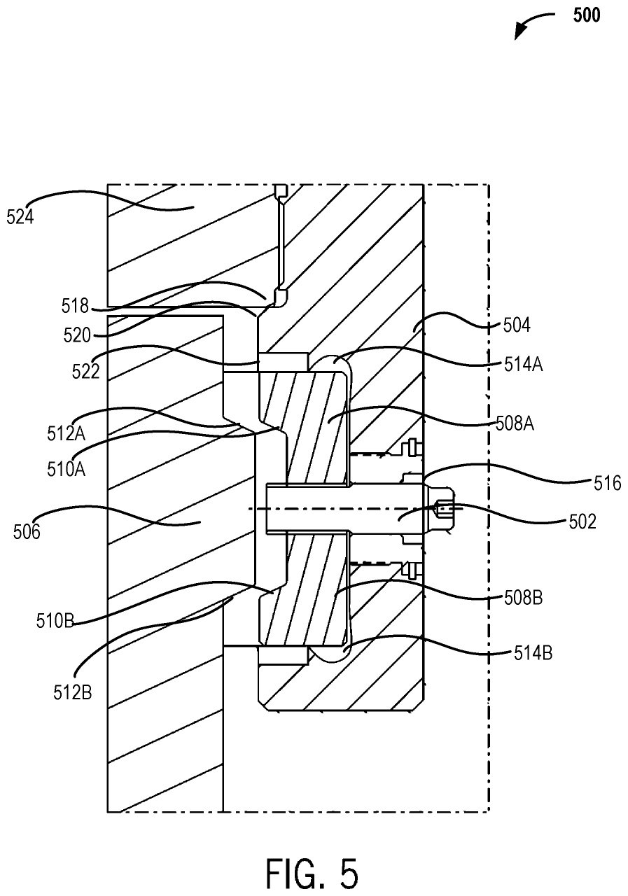

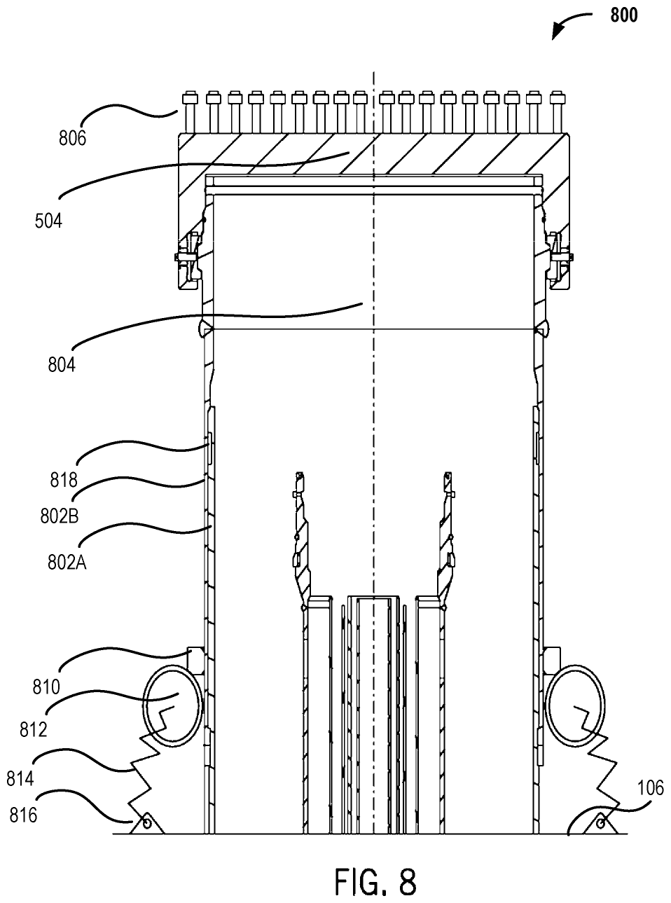

In at least one embodiment, the housing 412 extends above the annular feature 404. In at least one embodiment, the housing 412 may have, either integrally or associated therewith, universal high-capacity connector, as illustrated in FIG. 8. In at least one embodiment, therefore, the annular feature 404 is open at its top or may be enclosed at its top to completely enclose the casings 200. The housing 412 may be associated with a segmented clamp and a drive screw, as it is illustrated in callout 414A of FIG. 4 and described further with respect to FIGS. 5-7. In at least one embodiment, the housing 412 may be associated with a second segmented clamp, as illustrated within a callout 414B, to enable a releasable clamp of the housing 412 to the annular feature 404. The second segmented clamp can be located, as illustrated, on the housing 414, opposite the segmented clamp of an illustrated callout 414A.

In at least one embodiment, FIG. 5 illustrates details of a well structure adaption 600 in an unlatched position (uninstalled position). In at least one embodiment, the drive screw 502 can be used to enable the housing 504 to be releasably clamped to the annular feature 506 with the segmented clamp 508A, 508B providing the releasable clamping. The drive screw 502 is illustrated with the segmented clamp 508A, B closest to its screw head and away from an engagement with the annular feature 506. In at least one embodiment, all such aspects, including the annular feature 506, the housing 504, and the segmented clamps 508A, B are all annular and provided around the casings 200 of FIG. 2. The housing 504 can include at least one aspect of a renewable energy system thereon, as further illustrated in and discussed with respect to FIG. 5. In at least one embodiment, the at least one aspect is a universal high-capacity connector, as illustrated in FIG. 8.

In at least one embodiment, the well structure adaptation 500 includes angular clamping surfaces 510A, B of the segmented clamp 508A, B to engage corresponding clamping surfaces 512A, B of the annular feature 506. In at least one embodiment, the corresponding clamping surfaces enable a pre-load to apply to the well structure adaptation. In at least one embodiment, the well structure adaptation 500 includes radiused corners 514A, B located on the housing 504 in an area that is behind the segmented clamp 508A, B. This allows for reduction in stress, in the housing 504, from a use of the at least one aspect of a renewable energy system, as illustrated in FIG. 8.

In at least one embodiment, the well structure adaptation 500 includes at least two dogs 508A; 508B to form the segmented clamp 508A, 508B. The housing 504 can be releasably clamped to the annular feature 506 by the drive screw 502 being passed through threading on each of the at least two dogs 508A; B to move the at least two dogs 508A;B from the housing to the annular feature, which causes the releasable clamp between the housing 504 and the annular feature 506 at the surfaces 510A, B and 512A, B.

In at least one embodiment, the well structure adaptation 500 includes a guide bushing 516 that is associated with the drive screw 502 to provide access to the drive screw to enable the releasable clamp of the housing 504 to the annular feature 506. In at least one embodiment, well structure adaptation 500 includes a positive stop 520 of the housing 504 to engage a stop surface 518 of a high-capacity connector 524 that is associated with the annular feature 506. The high-capacity connector 524 can include a renewable energy system at its top surface. Further, the high-capacity connector 524 may also be a single or unibody structure with the annular feature 506. In at least one embodiment, the high-capacity connector 524 may be a distinct structure from the annular feature 506 and may be threaded together with the annular feature 506 by external components or by themselves.

The engagement of the positive stop 520 with the stop surface 518 can indicate that the housing 504 is pressured as far as it can move with respect to the high-capacity connector 524 or the annular feature 506. In at least one embodiment, the well structure adaptation 500 includes support features thereon, such as a universal high-capacity connector 806 that is illustrated in at least FIG. 8, to support at least one aspect of a renewable energy system thereon. In at least one embodiment, the well structure adaptation 500 includes wear pads 522 that are installed into the housing 504 to reduce wear and tear through repeated break-out and make-up of the segmented latch 508A, B with the annular feature.

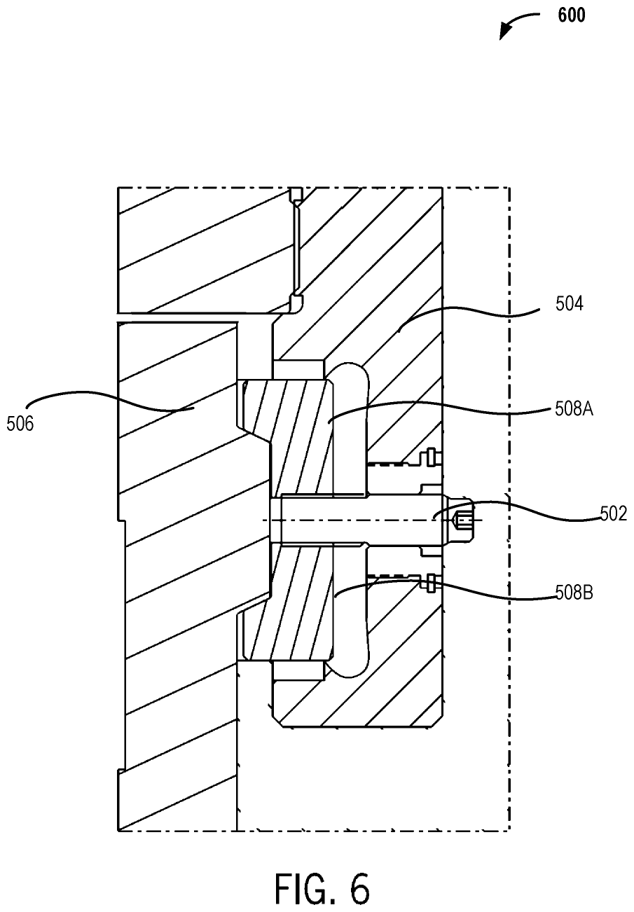

In at least one embodiment, FIG. 6 illustrates details of a well structure adaption 600 in a latched position (installed position). Different than in FIG. 5, as the details in FIG. 6 are to a latched position, the drive screw 502 is illustrated with the segmented clamp 508A, B away from its screw head and into an engagement with the annular feature 506. In at least one embodiment, in such a position, the load from the renewable energy system is transferred to the housing 504 and to the annular feature 506. Moreover, quick adjustments are possible by releasing the drive screw 502 to release the releasable clamp provided by the segmented clamp 508A, B. The housing 504, along with its renewable energy system, may be turned relative to the annular feature 506, for example, to adjust for optimum wind direction to harness the most favorable wind energy or other changes to benefit the renewable energy system.

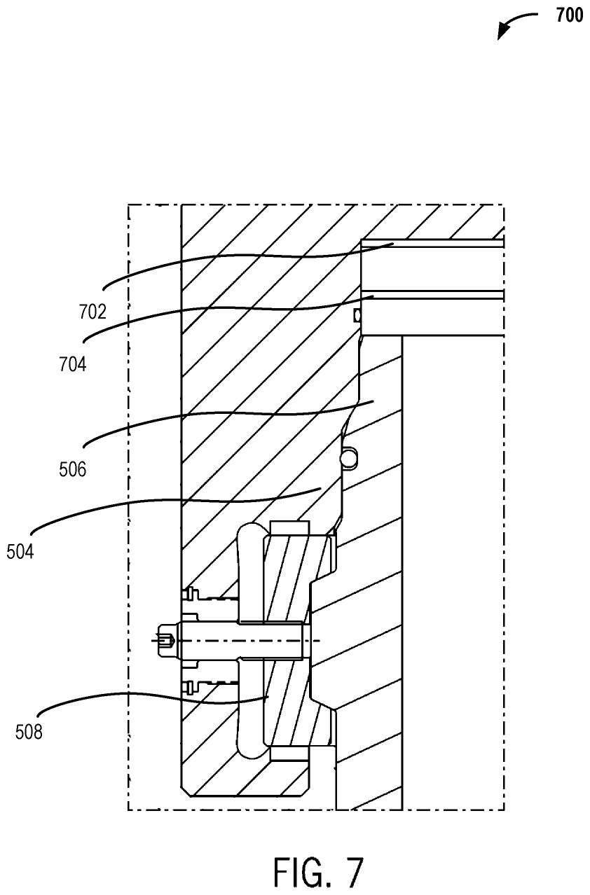

In at least one embodiment, FIG. 7 illustrates details of at least one separation 702; 704 enabled within a well structure adaption 700 for a reusable system. The separation may be between the housing 504 and the annular feature 506 to enable a media therein. In at least one embodiment, such a separation also enables an allowance for movement of the housing 504 with respect to the annular feature 506. Further, the separation 702; 704 may support a media that is liquid, gas, or solid therein (including fluid bearings or thrust bearings) and may also enable a vertical or other axial movement of the housing 504.

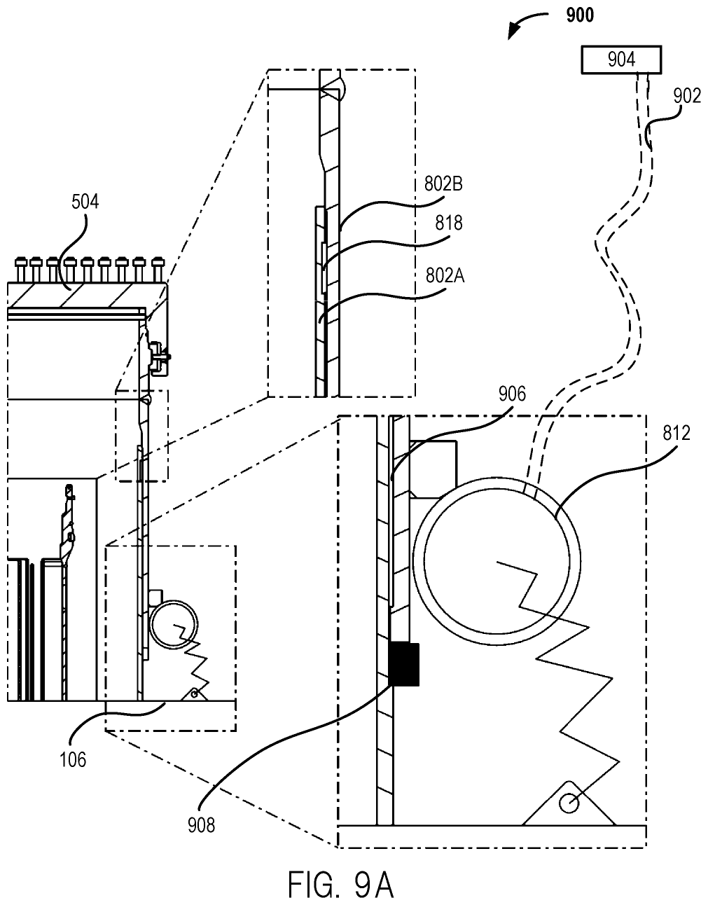

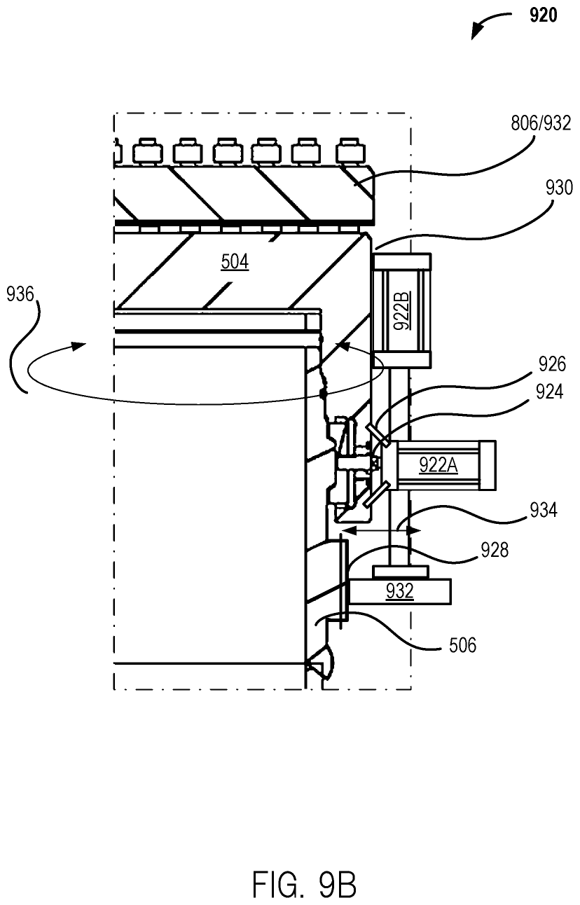

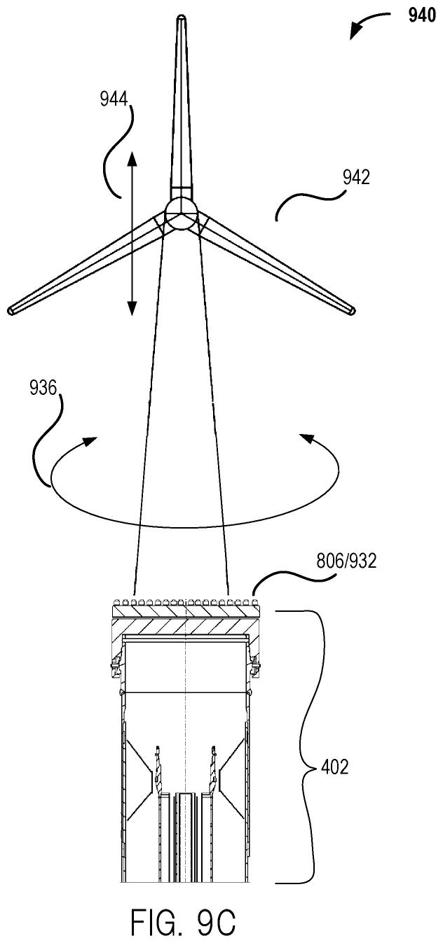

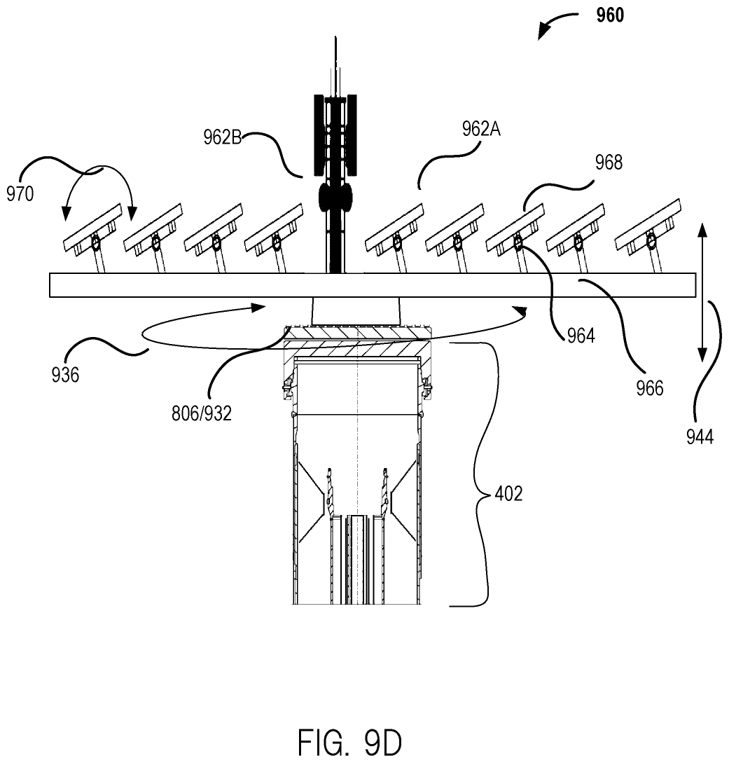

In at least one embodiment, FIG. 8 illustrates details a well structure adaption for a reusable system, such as a system for renewable energy generation, with buoyancy features. In at least one embodiment, the annular feature includes portions, such as an integrated portion 804, an inner body 802A, and an outer body 802B. As such, a cassion, such as described with respect to FIG. 4, is a split cassion. The outer body 802B includes the corresponding angular clamping surfaces 512A, B for engagement with angular clamping surfaces 510A, B of the segmented clamp 508A, B. Further, the inner body 802A or the outer body 802B may be associated with one or more rigid stops 818 (and further detailed in and discussed with respect to FIG. 9).

In at least one embodiment, the outer body 802B may be associated with a buoyancy canister 812 and with a tether point 810 to enable a tether 814 to an external surface 106 at another tether point 816. The tether point 810 is a weld-on support that allows buoyancy force to be reacted off the weld-on support on the outer body 802B of the split cassion. In at least one embodiment, the external surface 106 is external relative to the well structure adaptation 800 that may or may not include the casings 200 and concrete fillings associated therewith. In at least one embodiment, the outer body 802B can move relative to the inner body 802A to enable the housing 504 to move relative to the external surface 106 based in part on one or more rigid stops 818 provided for the inner body 802A or the outer body 802B. In at least one embodiment, the one or more rigid stops 818 prevents excessive movement, damaging movement, or unintended movement between the inner body 802A and the outer body 802B.

In at least one embodiment, FIG. 9A illustrates details a well structure adaption 900 with details of a buoyancy feature. In at least one embodiment, a buoyancy canister 812 may be filled with air from a surface or other location of a media system 904 via provided supply lines 902. In at least one embodiment, a media system 904 is an air compressor or a pump for media including for liquids. In at least one embodiment, air or other media may be pumped or removed to cause the buoyancy canister 812, which is fixedly attached to the outer body 802B to move the entire outer body 802B up or down relative to the inner body 802A. As a result, this enables the housing 504 and the annular feature having the outer body 802B to move relative to the external surface 106, based in part on one or more rigid stops 818, 908 provided for the inner body or the outer body that can restrict the movement, for instance.

In at least one embodiment, a spacing 906 between the inner body 802A and the outer body 802B allows the relative movement between the bodies. In at least one embodiment, one 908 of the one or more rigid stops 818; 908 enables a lowest point of relative movement as a safety stop in the event of a failure in the buoyancy canister 812 or for purposes of performing maintenance to any component of the systems described herein.

FIG. 9B illustrates details 920 for rotational movement associated with a well structure adaption, according to at least one embodiment. The rotational movement provides other axial movement than the elevation adjustment in FIG. 9A. In at least one embodiment, however, the details 920 may be applied to also allow for adjusting an elevation in one axial direction, instead of or together with the buoyancy feature in FIG. 9A. In at least one embodiment, the details 920 in FIG. 9B is a variation of an excerpt from FIG. 9A, with the well structure adaption in a latched position (installed position), as in FIG. 6.

To perform the rotational movement, a first motorized drive system 922A is provided. The first motorized drive system 922A may be protected from the elements by being within a casing or part 926 of the housing 504. The first motorized drive system 922A may be associated 924 with one or more drive screws 502 (such as in FIGS. 5 and 6). The first motorized drive system 922A may cause rotation of the drive screw upon a remote instruction, such as by causing power to be provided to the first motorized drive system 922A. The rotation of the drive screw causes the release of the releasable clamp provided by the segmented clamp 508A, B. The release, which is associated with the backing-off 934 of the drive screws 502 from being engaged with the corresponding clamping surfaces 512A, B of the annular feature 506, brings the segmented clamp 508A, B to the unlatched position (uninstalled position), as in FIG. 5.

In at least one embodiment, with the segmented clamp 508A, B in the unlatched position (uninstalled position), as in FIG. 5, a second motorized drive system 922B comes into action, such as by causing power to be provided to the second motorized drive system 922B. The second motorized drive system 922B may also be protected from the elements by being within a casing or part 930 of the housing 504 and may be associated, via a drive gear 932, with one or more ratchet profiles 928 on the annular feature 506. This second motorized drive system 922B may be an electric motor, like the first motorized drive system 922A. The rachet profiles 928 may be machined into a body of the annular feature 506. There may be one or more of such motorized drive systems to provide coordinated movement among one or more such segmented claims and one or more of such ratchet profiles.

In at least one embodiment, once the segmented clamps 508A, B are in the unlatched position (uninstalled position) so that the segmented clamps 508A, B are lifted off the annular feature 506, then rotation to the drive gear 932, caused by the second motorized drive system 922B and caused against the ratchet profiles 928, enables rotation that is one more axial movements 936 of the housing 504 with respect to the annular feature 506. The rotation of the housing 504 with respect to the annular feature 506 results in one more axial movements 936 also applied to the at least one aspect of the reusable system mounted to the housing 504 via the universal connector 806/932. Once at a desired axial location, in a rotational axis that is perpendicular with respect to an axis of the underlying casings, the housing 504 may be brought back to the latched position using the first motorized drive system 922A causing the segmented clamps 508A, B to move back 934 onto the corresponding clamping surfaces 512A, B of the annular feature 506. These actions may be performed remotely or using an unmanned vehicle instead of or together with the motorized drive systems 922A, B herein.

FIG. 9C illustrates details 940 of a renewable energy system (such as a wind turbine 942) associated with a well structure adaption 402 for renewable energy generation, according to at least one embodiment. In at least one embodiment, a wind turbine 942 may be provided on the universal connector 806/932, as illustrated in FIG. 9C. At least because of the details 920 in FIG. 9B, the wind turbine 942 is able to be moved in an elevation or vertical axis 944 that is parallel with respect to an axis of the underlying casings. Further, because of the details 920 in FIG. 9B, the wind turbine 942 is also able to be moved in the rotational axis 936 that is perpendicular with respect to an axis of the underlying casings. Therefore, it is possible to adjust for optimum wind direction to harness the most favorable wind energy or other changes to benefit the renewable energy system 942.

FIG. 9D illustrates details 960 of a reusable system 962A, B associated with a well structure adaption 402, according to at least one embodiment. In at least one embodiment, a platform 966 may be provided on the universal connector 806/932, as illustrated in FIG. 9D. At least because of the details 920 in FIG. 9B, the platform 942 is able to be moved in an elevation or vertical axis 944 that is parallel with respect to an axis of the underlying casings. Further, because of the details 920 in FIG. 9B, the platform 942 is also able to be moved in the rotational axis 936 that is perpendicular with respect to an axis of the underlying casings. The platform 966 may include solar panels 968 mounted thereon and that are also capable of independent movement 970 using separate motorized or manual drive systems 964. A manual drive system 964 may be a ball and socket joint that may be ratcheted and releasable to cause the independent movement 970 of the solar panels 968.

In at least one embodiment, the combination of movements 936, 944, 970 makes it possible to adjust for optimum solar direction to harness the most favorable solar energy or other changes to benefit the renewable energy system 962A of the reusable system 962A, B. Further, the platform 966 may include thereon a communications system 962B of the reusable system 962A, B. The communications system 962B may be powered by the renewable energy system 962A or the universal connector 806/932 may only include the communications system 962B so that there are no solar panels 968 and no platform 966 requirements. Then power to the communications system 962B may be provided from an external source. The communications system may include an antenna and all supporting aspects required to enable 5G®, 4G®, 4G LTE®, or related communications.

In at least one embodiment, the combination of movements 936, 944, 970 may be made using pre-programmed arrangements on computer and network aspects using the communications system. For example, the computer and network aspects allow determination of solar or wind patterns and allow the at least one motorized drive system to cause the optimum direction and height for the reusable system. Further, the computer and network aspects also allow determination of weather patterns and allow the at least one motorized drive system to cause a safest direction and height (such as lowest height) for the reusable system.

The computer and network aspects may include a distributed system. In at least one embodiment, a distributed system may include one or more computing devices. In at least one embodiment, one or more computing devices may be adapted to execute and function with a client application, such as with browsers or a stand-alone application, and are adapted to execute and function over one or more network(s).

In at least one embodiment, a server, having components may be communicatively coupled with computing devices via network and via a receiver device, if provided. In at least one embodiment, such components include processors, memory and random-access memory (RAM). In at least one embodiment, server may be adapted to operate services or applications to manage functions and sessions associated with database access and associated with computing devices.

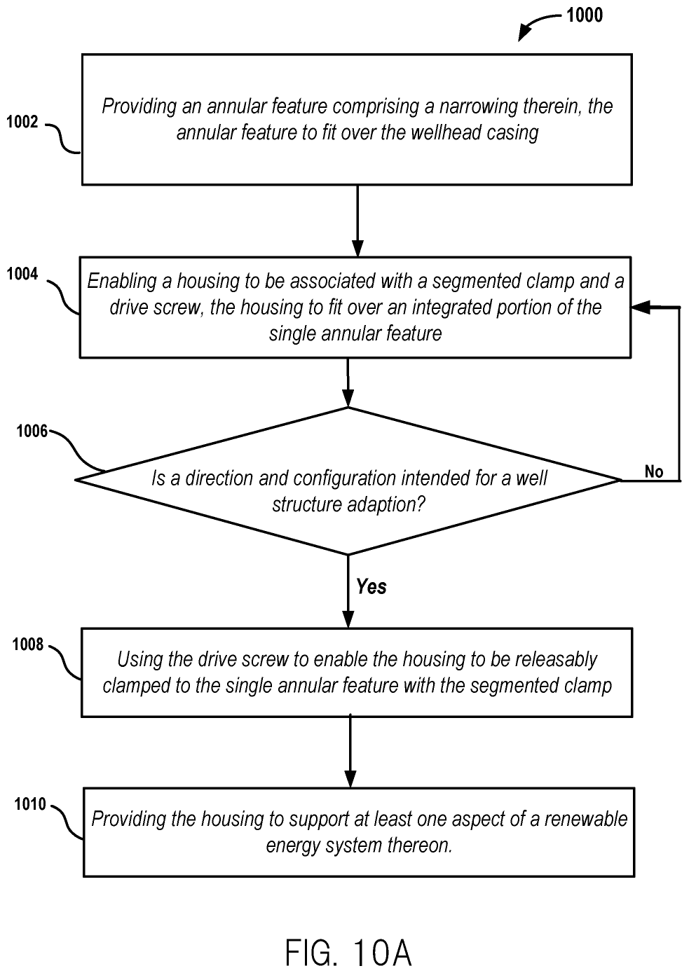

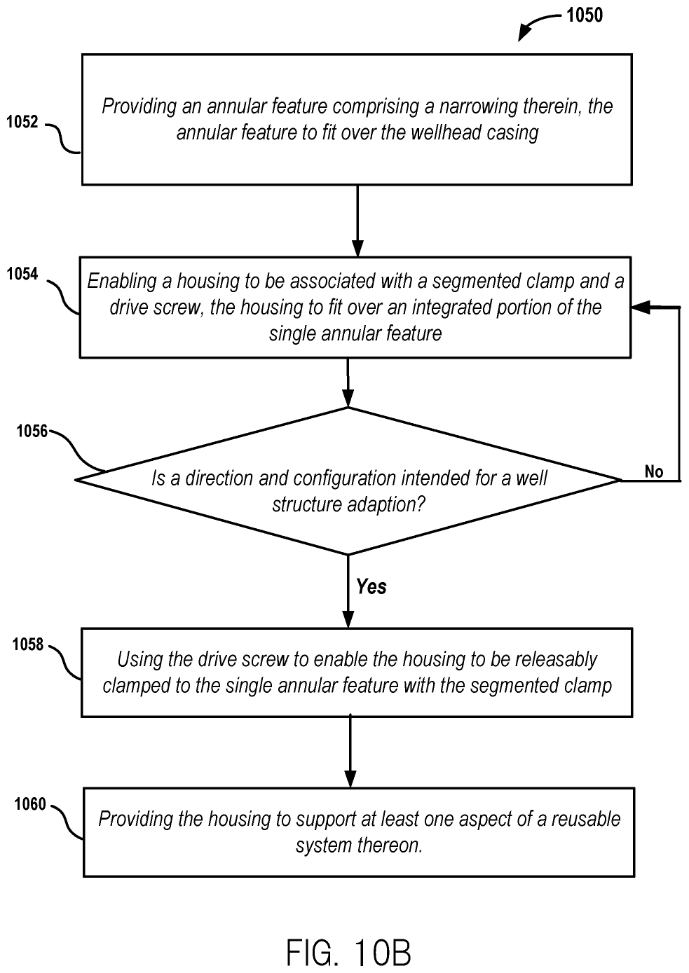

In at least one embodiment, server may be part of the communications system, but may also be at a distinct location from the communications system. In at least one embodiment, a server may also provide services or applications that are software-based in a virtual or a physical environment. In at least one embodiment, when server is a virtual environment, then components described with respect to the computer and network aspects are software components that may be implemented on a cloud. In at least one embodiment, this feature allows remote operation of a system as discussed at least in reference to FIGS. 9C-10B. In at least one embodiment, this feature also allows for remote access to information received and communicated between any of aforementioned devices. In at least one embodiment, one or more components of a server may be implemented in hardware or firmware, other than a software implementation described throughout herein. In at least one embodiment, combinations thereof may also be used.

In at least one embodiment, one computing device may be a smart monitor or a display having at least a microcontroller and memory having instructions to enable display of information monitored by a detector or receiver device. In at least one embodiment, one computing device may be a transmitter device to transmit directly to a receiver device or to transmit via a network to a receiver device and to a server, as well as to other computing devices.

In at least one embodiment, other computing devices may include portable handheld devices that are not limited to smartphones, cellular telephones, tablet computers, personal digital assistants (PDAs), and wearable devices (head mounted displays, watches, etc.). In at least one embodiment, other computing devices may operate one or more operating systems including Microsoft Windows Mobile®, Windows® (of any generation), and/or a variety of mobile operating systems such as iOS®, Windows Phone®, Android®, BlackBerry®, Palm OS®, and/or variations thereof.

In at least one embodiment, other computing devices may support applications designed as internet-related applications, electronic mail (email), short or multimedia message service (SMS or MMS) applications and may use other communication protocols. In at least one embodiment, other computing devices may also include general purpose personal computers and/or laptop computers running such operating systems as Microsoft Windows®, Apple Macintosh®, and/or Linux®. In at least one embodiment, other computing devices may be workstations running UNIX® or UNIX-like operating systems or other GNU/Linux operating systems, such as Google Chrome OS®. In at least one embodiment, thin-client devices, including gaming systems (Microsoft Xbox®) may be used as other computing device.

In at least one embodiment, network(s) may be any type of network that can support data communications using various protocols, including TCP/IP (transmission control protocol/Internet protocol), SNA (systems network architecture), IPX (Internet packet exchange), AppleTalk®, and/or variations thereof. In at least one embodiment, network(s) may be a networks that is based on Ethernet, Token-Ring, a wide-area network, Internet, a virtual net-work, a virtual private network (VPN), a local area network (LAN), an intranet, an extranet, a public switched telephone network (PSTN), an infra-red network, a wireless network (such as that operating with guidelines from an institution like the Institute of Electrical and Electronics (IEEE) 802.11 suite of protocols, Bluetooth®, and/or any other wireless protocol), and/or any combination of these and/or other networks.

In at least one embodiment, a server runs a suitable operating system, including any of operating systems described throughout herein. In at least one embodiment, server may also run some server applications, including HTTP (hypertext transport protocol) servers, FTP (file transfer protocol) servers, CGI (common gateway interface) servers, JAVA® servers, database servers, and/or variations thereof. In at least one embodiment, a database is supported by database server feature of a server provided with front-end capabilities. In at least one embodiment, such database server features include those available from Oracle®, Microsoft®, Sybase®, IBM® (International Business Machines), and/or variations thereof.

In at least one embodiment, a server is able to provide feeds and/or real-time updates for media feeds. In at least one embodiment, a server is part of multiple server boxes spread over an area but functioning for a presently described process for fast in-field chromatography. In at least one embodiment, server includes applications to measure network performance by network monitoring and traffic management. In at least one embodiment, a provided database enables information storage from a wellsite, including user interactions, usage patterns information, adaptation rules information, and other information.

In at least one embodiment, FIG. 10A illustrates a method 1000 associated with a well structure adaption for renewable energy generation. In at least one embodiment, the method 1000 includes providing (1002) an annular feature comprising a narrowing therein, the annular feature to fit over the wellhead casing. A further step of the method 1000 includes enabling (1004) a housing to be associated with a segmented clamp and a drive screw. In this step, the housing can be fit over a portion of the annular feature.

Yet another step of the method 1000 includes a verification (1006) for a direction and a height configuration intended for a well structure adaptation. In at least one embodiment, this may be the direction and the height for the wind turbine or a platform having solar panels. In at least one embodiment, the direction and the height may be controlled by at least one motorized drive system associated with one or more of the annular feature or the housing to enable one more axial movements of the at least one aspect of the renewable energy system herein. In at least one embodiment, these may be initial direction and configuration that may be dynamically altered over time. In at least one embodiment, a step of the method 1000 includes using (1008) the drive screw to enable the housing to be releasably clamped to the annular feature with the segmented clamp. The method 1000 can include providing (1010) the housing with or to support at least one aspect of a renewable energy system thereon.

In at least one embodiment, the method 1000 herein includes steps or substeps for enabling an inner body and an outer body for the annular feature. The inner body may be associated with one or more rigid stops, with a buoyancy canister, and with a tether point to enable a tether to an external surface relative to the well structure adaptation

In at least one embodiment, the method 1000 herein includes steps or substeps for allowing relative movement of the outer body relative to the inner body to enable the housing to move relative to the external surface based in part on one or more rigid stops provided for the inner body or the outer body. In at least one embodiment, the rigid stop is provided on an inner body 802A, at a maximum altitude determined for a wind turbine. This at least prevents the wind turbine from disengaging in the event of an accident or failure.

In at least one embodiment, the method 1000 herein includes steps or substeps for enabling a separation between the housing and the annular feature to include a media therein and to allow for movement of the housing with respect to the annular feature. In at least one embodiment, the method 1000 herein includes steps or substeps for enabling the releasably clamp of the housing to the annular feature by a second segmented clamp in addition to the segmented clamp. The second segmented clamp can be located on the housing opposite the segmented clamp.

In at least one embodiment, the method 1000 herein includes steps or substeps for enabling angular clamping surfaces of the segmented clamp to engage corresponding clamping surfaces of the annular feature. In at least one embodiment, the method 1000 herein includes steps or substeps for radiused corners located on the housing in an area behind the segmented clamp to reduce stress, in the housing, from a use of the at least one aspect of a reusable system.

In at least one embodiment, the method 1000 herein includes steps or substeps for forming the segmented clamp from at least two dogs that are associated together with the drive screw. In at least one embodiment, the method 1000 herein includes steps or substeps for passing the drive screw through threading on each of the at least two dogs to enable the releasably clamp by movement of the at least two dogs from the housing to the annular feature.

In at least one embodiment, the method 1000 herein includes steps or substeps for enabling a guide bushing to be associated with the drive screw to provide access to the drive screw to enable the releasably clamp of the housing to the annular feature. In at least one embodiment, the method 1000 herein includes steps or substeps for providing a positive stop of the housing to engage a surface of the annular feature to indicate that the housing is pressured against the annular feature. In at least one embodiment, the method 1000 herein includes steps or substeps for associating at least one support features with the housing to enable the support for the at least one aspect of a reusable system thereon. In at least one embodiment, the method 1000 herein includes steps or substeps for associating at least one motorized drive system with one or more of the annular feature or the housing. The at least one motorized drive system can enable one more axial movements of the at least one aspect of the reusable system.

In at least one embodiment, FIG. 10B illustrates a method 1050 associated with a well structure adaption for a reusable system. In at least one embodiment, the method 1050 includes providing (1052) an annular feature comprising a narrowing therein, the annular feature to fit over the wellhead casing. A further step of the method 1050 includes enabling (1054) a housing to be associated with a segmented clamp and a drive screw. In this step, the housing can be fit over a portion of the annular feature. Yet another step of the method 1050 a verification (1056) is for a direction and height configuration intended for a well structure adaptation. In at least one embodiment, the direction and the height may be controlled by at least one motorized drive system associated with one or more of the annular feature or the housing to enable one more axial movements of the at least one aspect of the reusable system herein.

In at least one embodiment, the verification (1056) using manual inputs or inputs via the at least one motorized drive system may consider the optimizations described above with respect to the optimal direction and height of the wind turbine or solar panels (or of the communications system, if required to improve signal strength). In at least one embodiment, there may be initial direction and configuration that may be dynamically altered over time. In at least one embodiment, a step of the method 1050 includes using (1058) the drive screw to enable the housing to be releasably clamped to the annular feature with the segmented clamp. The method 1050 can include providing (1060) the housing with or to support at least one aspect of a reusable system thereon.

In at least one embodiment, even though the above discussion provides at least one embodiment having implementations of described techniques, other architectures may be used to implement described functionality, and are intended to be within scope of this disclosure. In addition, although specific responsibilities may be distributed to components and processes, they are defined above for purposes of discussion, and various functions and responsibilities might be distributed and divided in different ways, depending on circumstances.

In at least one embodiment, although subject matter has been described in language specific to structures and/or methods or processes, it is to be understood that subject matter claimed in appended claims is not limited to specific structures or methods described. Instead, specific structures or methods are disclosed as example forms of how a claim may be implemented.

From all the above, a person of ordinary skill would readily understand that the tool of the present disclosure provides numerous technical and commercial advantages and can be used in a variety of applications. Various embodiments may be combined or modified based in part on the present disclosure, which is readily understood to support such combination and modifications to achieve the benefits described above.

What is claimed is:

1. A well structure adaption (402) to be used with a wellhead casing (110; 202), the well structure adaption characterized by:
an annular feature (404; 506) characterized by a narrowing (406) therein, the annular feature to fit over the wellhead casing; and
a housing (412; 504) associated with a segmented clamp (508) and a drive screw (502), the housing to fit over an integrated portion (804) of the annular feature, the drive screw to enable the housing to be releasably clamped to the annular feature with the segmented clamp, and the housing to support at least one aspect of a reusable system (942; 962A; 962B) thereon.

2. The well structure adaptation of claim 1, further characterized by:
an inner body (802A) and an outer body (802B) for the annular feature, the inner body associated with a buoyancy canister (812) and with a tether point (810) to enable a tether to an external surface (106) relative to the well structure adaptation, the outer body to move relative to the inner body to enable the housing to move relative to the external surface based in part on one or more rigid stops (818) provided for the inner body or the outer body.

3. The well structure adaptation of claim 1, further characterized by:
a separation (702) between the housing and the annular feature to enable a media therein and to enable an allowance for movement of the housing with respect to the annular feature.

4. The well structure adaptation of claim 1, further characterized by:
a second segmented clamp to enable the releasably clamp of the housing to the annular feature, the second segmented clamp to be located on the housing opposite the segmented clamp.

5. The well structure adaptation of claim 1, further characterized by:
angular clamping surfaces (510A, B) of the segmented clamp to engage corresponding clamping surfaces of the annular feature, the corresponding clamping surfaces to enable a pre-load to apply to the well structure adaptation.

6. The well structure adaptation of claim 1, further characterized by:
radiused corners (514A, B) located on the housing in an area behind the segmented clamp to reduce stress, in the housing, from a use of the at least one aspect of the reusable system.

7. The well structure adaptation of claim 1, further characterized by:
at least two dogs (508A, 508B) to form the segmented clamp, wherein the housing to be releasably clamped to the annular feature comprises the drive screw to pass through threading on each of the at least two dogs to move the at least two dogs from the housing to the annular feature.

8. The well structure adaptation of claim 1, further characterized by:
a guide bushing (516) associated with the drive screw to provide access to the drive screw to enable the releasably clamp of the housing to the annular feature.

9. The well structure adaptation of claim 1, further characterized by:
a positive stop (520) of the housing to engage a surface (518) of a universal high-capacity connector (524) to indicate that the housing is pressured against the universal high-capacity connector or the annular feature.

10. The well structure adaptation of claim 1, further characterized by:
at least one motorized drive system (922A; 922B) to be associated with one or more of the annular feature or the housing, the at least one motorized drive system to enable one more axial movements (936; 944) of the at least one aspect of the reusable system.

11. A method (1000; 1050) for a well structure adaption to be used with a wellhead casing, the well structure adaption characterized by:
providing (1002; 1052) an annular feature characterized by a narrowing therein, the annular feature to fit over the wellhead casing; and
enabling (1004; 1054) a housing to be associated with a segmented clamp and a drive screw, the housing to fit over a portion of the annular feature, the drive screw to enable (1008; 1059) the housing to be releasably clamped to the annular feature with the segmented clamp, and the housing to support (1010; 1060) at least one aspect of a reusable system thereon.

12. The method of claim 11, further characterized by:
enabling an inner body and an outer body for the annular feature, the inner body associated with one or more rigid stops, with a buoyancy canister, and with a tether point to enable a tether to an external surface relative to the well structure adaptation; and
allowing relative movement of the outer body relative to the inner body to enable the housing to move relative to the external surface based in part on one or more rigid stops provided for the inner body or the outer body.

13. The method of claim 11, further characterized by:
enabling a separation between the housing and the annular feature to comprise a media therein and to allow for movement of the housing with respect to the annular feature.

14. The method of claim 11, further characterized by:
enabling the releasably clamp of the housing to the annular feature by a second segmented clamp in addition to the segmented clamp, the second segmented clamp to be located on the housing opposite the segmented clamp.

15. The method of claim 11, further characterized by:
enabling angular clamping surfaces of the segmented clamp to engage corresponding clamping surfaces of the annular feature.

16. The method of claim 11, further characterized by:
providing radiused corners located on the housing in an area behind the segmented clamp to reduce stress, in the housing, from a use of the at least one aspect of the reusable system.

17. The method of claim 11, further characterized by:
forming the segmented clamp from at least two dogs associated together with the drive screw; and
passing the drive screw through threading on each of the at least two dogs to enable the releasably clamp by movement of the at least two dogs from the housing to the annular feature.

18. The method of claim 11, further characterized by:
enabling a guide bushing to be associated with the drive screw to provide access to the drive screw to enable the releasably clamp of the housing to the annular feature.

19. The method of claim 11, further characterized by:
providing a positive stop of the housing to engage a surface of the universal high-capacity connector to indicate that the housing is pressured against the universal high-capacity connector or the annular feature.

20. The method of claim 11, further characterized by:
associating at least one motorized drive system with one or more of the annular feature or the housing, the at least one motorized drive system to enable one more axial movements of the at least one aspect of the reusable system.
